(19) United States
(12) Patent Application Publication
(10) Pub. No.: US 2014/0368388 A1
(43) Pub. Date: Dec. 18, 2014

(54) HOUSING OF ELECTRONIC DEVICE, AND METHOD FOR MAKING THE HOUSING

(71) Applicants: FIH (Hong Kong) Limited, Kowloon (HK); SHENZHEN FUTAIHONG PRECISION INDUSTRY CO., LTD., Shenzhen (CN)

(72) Inventors: XING-HUA HAN, Shenzhen (CN); XU LIU, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 14/023,122

(22) Filed: Sep. 10, 2013

(30) Foreign Application Priority Data
Jun. 17, 2013 (CN) 2013102388835

(51) Int. Cl. H01Q 1/24

(52) U.S. Cl. CPC H01Q 1/243
USPC 343/702; 427/58

(57) ABSTRACT

A housing of an electronic device includes a main body and an antenna formed in the main body. The main body includes an outer surface and an inner surface. The outer surface defines a groove therein. The antenna includes an antenna portion received in the groove, and a connecting portion received in the inner surface of the main body. The connecting portion is connected to the antenna portion.

### BACKGROUND

1. Technical Field

The present disclosure relates to housings of electronic devices, and more particularly to a method for making the housings.

2. Description of Related Art

With miniaturization of electronic devices, antennas of the electronic devices must be miniaturized as well. Antennas can be external antennas or be built into the electronic devices. However, both kinds of antennas have disadvantages. External antennas can be thin and simple, but are easily damaged. Built-in antennas have complex structures and are thick, but have lower signal intensities than external antennas.

Therefore, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of an electronic device in accordance with an exemplary embodiment.

FIG. 2 is an exploded view of the electronic device of FIG. 1.

FIG. 3 is another exploded view of the electronic device of FIG. 1.

FIG. 4 is a cross-sectional view of the electronic device of FIG. 1 taken along line IV-IV.

### DETAILED DESCRIPTION

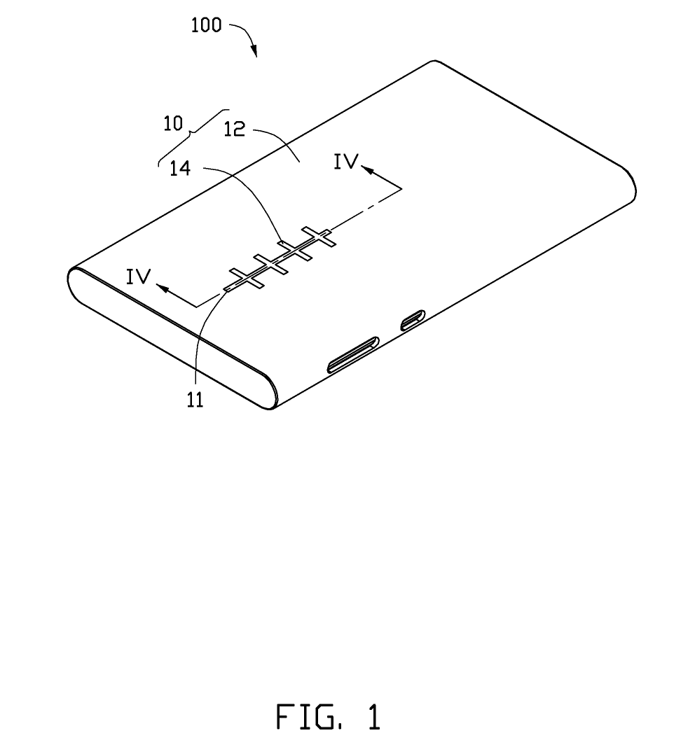

FIGS. 1-4 show an exemplary embodiment of an electronic device 100 (i.e., a mobile phone) for describing the disclosure. The electronic device 100 includes a housing 10. The housing 10 includes a main body 12 and an antenna 14. In this embodiment, the housing 10 is a rear cover of the electronic device 100.

The main body 12 includes a circuit board (not shown) received in the main body 12 to electrically connect to the antenna 14, and a battery (not shown) received in the main body 12 to power the electronic device 100.

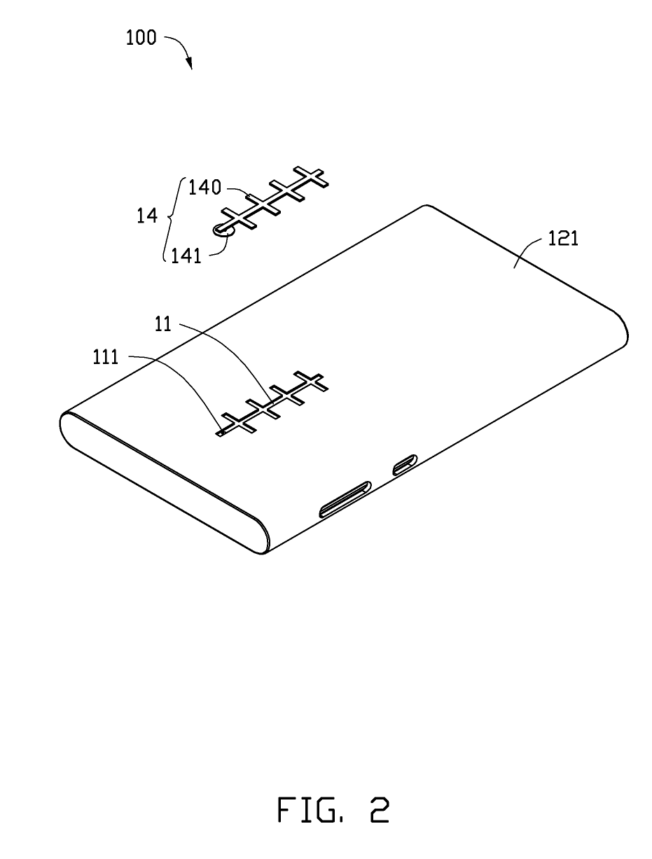

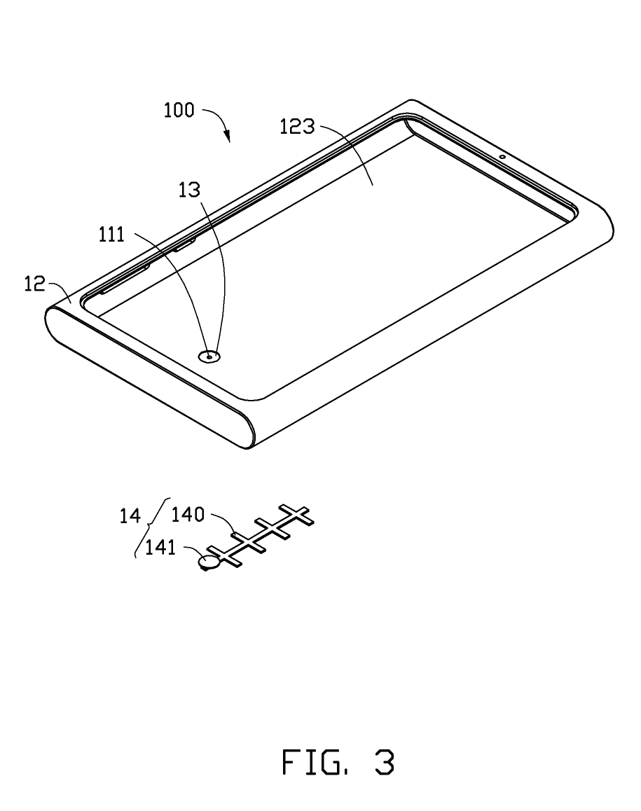

The main body 12 includes an outer surface 121 and an inner surface 123. The outer surface 121 defines a groove 11 therein (see FIG. 2), and the inner surface 123 defines a limiting slot 13 therein (see FIG. 3). The groove 11 defines a through hole 111, which communicates with the groove 11 and the limiting slot 13.

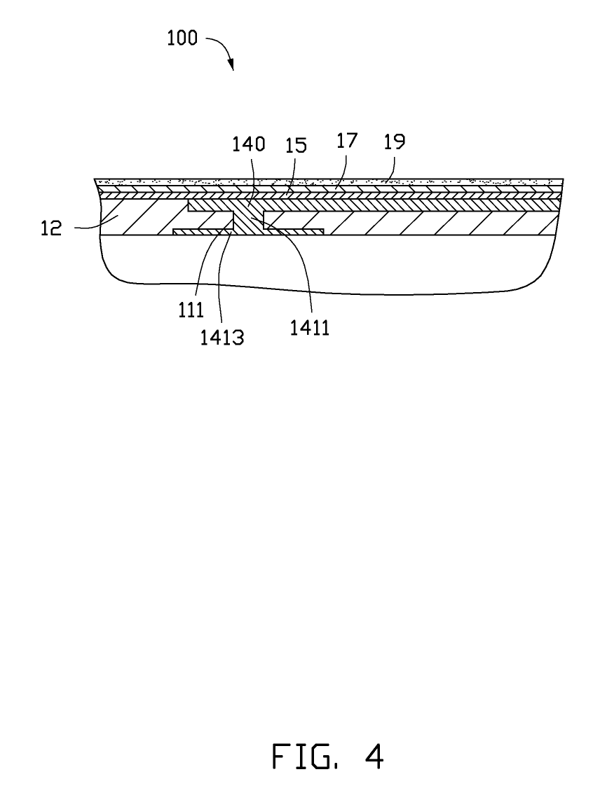

The antenna 14 is a metal layer, made of, for example, silver or copper. The antenna 14 includes an antenna portion 140 and a connecting portion 141 formed on one end of the antenna portion 140. The antenna portion 140 is received in the groove 11 of the housing 10. Referring to FIG. 4, the connecting portion 141 includes a first connecting part 1411 and a second connecting part 1413. The first connecting part 1411 has a shape corresponding to a shape of the through hole 111 and is received in the through hole 111. The second connecting part 1413 has a shape corresponding to a shape of the limiting slot 13 and is received in the limiting slot 13. The second connecting part 1413 and the limiting slot 13 are bigger than the first connecting part 1411 and the through hole 111. Therefore, the antenna 14 is securely fixed in the main body 12. The second connecting part 1413 is electrically connected to the circuit board.

Also referring to FIG. 4, the housing 10 further includes a base layer 15 formed on the outer surface 121 of the main body 12, a color layer 17 formed on the base layer 15, and a top layer 19 formed on the color layer 17.

The base layer 15 can be an ultraviolet curing paint layer formed by spraying and has a thickness of about 8 micrometers (μm) to about 12 μm. The base layer 15 enhances bonding of the color layer 17 to the outer surface 121 of the main body 12.

The color layer 17 can be an ultraviolet curing paint layer formed by spraying and has a thickness of about 15 μm to about 22 μm.

The top layer 19 can be an ultraviolet curing paint layer formed by spraying and has a thickness of about 8 μm to about 10 μm. The top layer 19 provides the housing 10 with excellent abrasion resistance.

A method for making the housing 10 can include the following steps.

An injection mold (not shown) having a cavity formed therein is provided. The cavity is shaped corresponding to a shape of the main body 12 of the housing 10.

Molten resin or molten plastic is injected into the cavity, and is then cooled to form the main body 12.

To form the antenna 14, an electrically-conductive slurry containing metal powder and resin is provided. The metal powder can be, for example, silver powder or copper powder. The metal powder has a mass percentage of about 85% to about 95% of the slurry. The resin can be, for example, acrylic resin having a mass percentage of about 5% to about 15% of the slurry.

A diluting agent is provided. The diluting agent contains cyclohexane having a mass percentage of about 70% to about 90% of the diluting agent, and butanone having a mass percentage of about 10% to about 30% of the diluting agent.

The diluting agent is added to the slurry, both the diluting agent and slurry being at about room temperature. The mass ratio between the diluting agent and the slurry is between about 1:19 and about 1:9.

An adhesive tape (not shown) is provided and is attached to the inner surface 123 of the main body 12 to seal the limiting slot 13. The diluted slurry is then poured in the groove 11 to fill the groove 11, the through hole 111, and the limiting slot 13. The adhesive tape prevents the diluted slurry from flowing out of the limiting slot 13.

The diluted slurry in the groove 11, the through hole 111, and the limiting slot 13 is baked in an oven having an internal temperature of between about 80 degrees Celcius (° C.) and about 120° C. to remove the diluting agent and harden the slurry, thereby forming the antenna 14. The baking process lasts for about 45 minutes (min) to about 60 min.

The antenna 14 can be polished by a polishing machine (not shown) for about 4 min to about 6 min to smoothen a surface of the antenna 14.

The base layer 15 is formed by spraying a first ultraviolet paint layer on the outer surface 121 and the antenna 14. The first ultraviolet paint is baked in an oven having an internal temperature of between about 60° C. and about 80° C. for about 10 min to about 40 min, and then is ultraviolet-cured at an energy of about 1000 megajoules (MJ) to about 2000 MJ for about 3 seconds to about 20 seconds.

The color layer 17 is formed by spraying a second ultraviolet paint layer on the base layer 15. The second ultraviolet paint layer is baked in an oven having an internal temperature of between about 50° C. and about 70° C. for about 10 min to about 40 min, and then is ultraviolet-cured at an energy of about 500 MJ to about 1500 MJ for about 3 seconds to about 10 seconds.

The top layer 19 is formed by spraying a third ultraviolet paint layer on the color layer 17. The third ultraviolet paint layer is baked in an oven having an internal temperature of between about 80° C. and about 95° C. for about 10 min to about 40 min, and then is ultraviolet-cured at an energy of about 1000 MJ to about 2000 MJ for about 3 seconds to about 15 seconds.

Pencil hardness of the housing 10 has been tested using a pencil scratching tester (not shown). The test indicated that the pencil hardness of the housing 10 was about 1 H to about 3 H.

Abrasion resistance of the housing 10 has been tested using an abrasion tester. The test indicated that only about 0% to about 2% of the top layer 19 peeled off.

Adhesion resistance of the housing 10 has also been tested using a cross-cut method. The test indicated that only about 2% to about 4% of the top layer 19 peeled off.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A housing, comprising:
a main body having an outer surface and an inner surface, the outer surface defining a groove therein; and
an antenna comprising an antenna portion and a connecting portion, the antenna portion being received in the groove, the connecting portion connecting the antenna portion and being received in the inner surface of the main body.

2. The housing as claimed in claim 1, wherein the inner surface of the main body defines a limiting slot, the connecting portion comprises a first connecting part and a second connecting part, the second connecting part has a shape mating with the limiting slot and is received in the limiting slot.

3. The housing as claimed in claim 2, wherein the groove defines a through hole communicating the groove and the limiting slot, the first connecting part has a shape mating with the through hole and is received in the through hole, the second connecting part has a diameter larger than the diameters of the through hole and the first connecting part.

4. The housing as claimed in claim 1, further comprising a base layer formed on the outer surface of the main body and the antenna, a color layer formed on the base layer, and a top layer formed on the color layer.

5. The housing as claimed in claim 4, wherein the base layer, the color layer, and the top layer are made of ultraviolet curing paint.

6. The housing as claimed in claim 1, wherein the antenna is a silver layer or a copper layer.

7. A method for making a housing, comprising:
providing an injection mold having a cavity formed therein;
injecting molten resin or molten plastic into the cavity and then cooling the molten resin or molten plastic to form a main body, the main body having an outer surface defining a groove therein, and an inner surface defining a limiting slot therein, the groove communicating with the limiting slot;
filling the groove and the limiting slot with electrically-conductive slurry; and
baking the slurry in the groove and limiting slot to form an antenna.

8. The method as claimed in claim 7, wherein the slurry comprises metal powder and resin, the metal powder is silver powder or copper powder having a mass percentage of about 85% to about 95% of the slurry, the resin is acrylic resin having a mass percentage of about 5% to about 15% of the slurry.

9. The method as claimed in claim 8, wherein the groove defines a through hole, the through hole communicates with the groove and the limiting slot, the slurry is filled in the groove, the through hole, and the limiting slot.

10. The method as claimed in claim 9, further comprising a step of diluting the slurry using a diluting agent before the slurry is filled in the groove, the through hole, and the limiting slot, the mass ratio between the diluting agent and the slurry is about 1:19 and 1:9.

11. The method as claimed in claim 10, wherein the diluting agent comprises cyclohexane having a mass percentage of about 70% to about 90%, and butanone having a mass percentage of about 10% to about 30%.

12. The method as claimed in claim 11, wherein baking the slurry is carried out in an oven having an internal temperature of about 80° C. to about 120° C. for about 45 min to about 60 min to remove the diluting agent.

13. The method as claimed in claim 7, further comprising steps of forming a base layer, a color layer, and a top layer on the outer surface of the main body and the antenna after the baking process.

14. An electronic device, comprising:
a housing, the housing comprising:
a main body having an outer surface and an inner surface, the outer surface defining a groove therein; and
an antenna comprising an antenna portion and a connecting portion, the antenna portion being received in the groove, the connecting portion connecting the antenna portion and being received in the inner surface of the main body.

15. The electronic device as claimed in claim 14, wherein the inner surface of the main body defines a limiting slot, the connecting portion comprises a first connecting part and a second connecting part, the second connecting part has a shape mating with the limiting slot and is received in the limiting slot.

16. The electronic device as claimed in claim 15, wherein the groove defines a through hole communicating with the groove and the limiting slot, the first connecting part has a shape mating with the through hole and is received in the through hole, the second connecting part has a diameter larger than the diameters of the through hole and the first connecting part.
